(19) United States
(12) Patent Application Publication
(10) Pub. No.: US 2005/0140565 A1
(43) Pub. Date: Jun. 30, 2005

(54) Mobile telephone comprising wraparound display

(76) Inventor: Rainer Krombach, Rettenbach (DE)

Correspondence Address: BELL, BOYD & LLOYD, LLC, P. O. BOX 1135, CHICAGO, IL, 60690-1135, US

(21) Appl. No.: 10/504,202

(22) PCT Filed: Feb. 3, 2003
(86) PCT No.: PCT/DE03/00299

(30) Foreign Application Priority Data
Feb. 20, 2002 (DE) 10208196.4

(51) Int. Cl. G09G 5/00

(52) U.S. Cl. 345/1.1

(57) ABSTRACT

A mobile radio telephone having a display device for representing informational content is disclosed. The display device is configured such that it extends over the front and rear faces of the mobile radio telephone. Additionally, the mobile radio telephone includes one or more sensors that evaluate the rotational movement of the mobile radio telephone and convert the movement into displacement or movement of the informational content or a cursor displayed on the display device.

The invention relates to a mobile radio telephone in accordance with the preamble of the patent claim.

This type of mobile radio telephone or mobile telephone, also called a cell phone, generally features a display device on the front face. This is preferably used to display telephone numbers and entries in a telephone book or other files, as well to operate the device itself.

It is only possible to display Internet pages to a limited extent on such a display.

The object of the invention is to improve the display of Internet pages in particular.

This object is achieved in accordance with the invention by the features specified in the patent claim.

The invention is described below on the basis of an exemplary embodiment.

The mobile radio telephone or mobile telephone in accordance with the invention features a full display or a wraparound display. To implement the full display a display device is arranged on the front and on the back of the mobile telephone for example. The increased surface of the display device or of the two display devices allows more content, of downloaded Internet pages for example, to be displayed.

In a preferred embodiment the two displays are convex so that the user can easily read the text displayed when the mobile telephone is rotated

The mobile radio telephone in accordance with the invention further features sensors
which detect and evaluate a rotational movement of the mobile radio telephone. the rotational movement is preferably around the lengthwise axis of the mobile radio telephone, so that the display devices on the front and rear face of the telephone can be viewed by a user. Through the rotational movement of the mobile radio telephone the displayed content is continuously scrolled onwards. The user thus has the opportunity, through the rotational movement, of continuously moving his “viewing window” upwards or downwards over a page.

It is also possible to use the rotational movement to control the cursor, which is then moved upwards or downwards.

Similarly it is possible, by tilting the device towards one page or the other to move the cursor or the view window to precisely this page. Further sensors are provided in the mobile radio telephone to record the tilting movement.

### BACKGROUND

The present disclosure relates to a mobile radio telephone and, more particularly, a mobile radio telephone having a display device used to display contact information. This type of mobile radio telephone or mobile telephone, also called a cell phone, generally features a display device on the front face. The display device is preferably used to display telephone numbers and entries of a telephone book or other files, as well to operate the device itself. When displaying Internet pages, however, it is only possible to display such content to a limited extent on such a display.

### SUMMARY

The presently disclosed mobile radio telephone features an apparatus that improves the display of Internet pages, for example.

According to an embodiment, a mobile radio telephone comprising a display device to display information content, the display configured to extend over front and rear faces of the mobile radio telephone and at least one sensor configured to sense and evaluate rotational movement of the mobile terminal radio telephone and convert the sensed rotational movement into control of movement of the displayed information content within the display device.

### DETAILED DESCRIPTION OF THE PRESENT EXAMPLES

A mobile radio telephone or mobile telephone including the disclosed apparatus features a full display or a wraparound display. To implement the full display, a display device is arranged on the front and on the back of the mobile telephone, for example. The increased surface of the display device or of the two display devices allows more content, of downloaded Internet pages, for example, to be displayed.

In one example, the two displays may be convex in shape so that a user can easily read the text displayed when the mobile telephone is rotated.

In another example, a mobile radio telephone may further include sensors that detect and evaluate rotational movement of the mobile radio telephone. The rotational movement around the lengthwise axis of the mobile radio telephone can be sensed, for example, so that the display devices on the front and rear face of the telephone can be viewed by a user. Through the rotational movement of the mobile radio telephone, the displayed content can be continuously scrolled onwards. The user, thus, has the opportunity, through the rotational movement, of continuously moving his “viewing window” upwards or downwards over a page. It is also possible to use the rotational movement to control a cursor, which is then moved upwards or downwards.

According to another example, further sensors are provided in the mobile radio telephone to record the tilting movement. Thus, it is possible through the use of such sensor to tilt the device towards one page or the other, for example, in order to move the cursor or the view window to precisely this page.

Although preferred examples of the present apparatus have been disclosed for illustrative purposes, those of ordinary skill in the art will appreciate that the scope of this patent is not limited thereto. On the contrary, this patent covers all apparatus falling within the scope of the appended claims.

1-3. (canceled)

4. A mobile radio telephone comprising:
a display device to display information content, the display configured to extend over front and rear faces of the mobile radio telephone, and
at least one sensor configured to sense and evaluate rotational movement of the mobile terminal radio telephone and convert the sensed rotational movement into control of movement of the displayed information content within the display device.

5. A mobile radio telephone as defined in claim 4, wherein the at least one sensor is further configured to convert the sensed rotational movement into control of movement of a cursor displayed on the display device within the display device.

6. A mobile radio telephone as defined in claim 5, wherein the at least one sensor is configured to control the movement the cursor in the same direction of tilt movement of the mobile radio telephone.
